(19) United States
(12) Patent Application Publication
(10) Pub. No.: US 2001/0020569 A1
(43) Pub. Date: Sep. 13, 2001

(54) Transfer device

(76) Inventors: Toshihiko Arai, Kanagawa-ken (JP); Nobuyoshi Maeda, Kanagawa-ken (JP)

Correspondence Address: Thomas R. Morrison, Esq., MORRISON LAW FIRM, 145 North Fifth Avenue, Mount Vernon, NY, 10550, US

(21) Appl. No.: 09/793,692

(22) Filed: Feb. 26, 2001

(30) Foreign Application Priority Data
Mar. 10, 2000 (JP) 2000-067109

(51) Int. Cl. B65G 37/00

(52) U.S. Cl. 198/570

(57) ABSTRACT

The present invention is a transfer device for transferring large blank materials through multi-stage processing by engaging and employing both a crossbar-type and a finger-type transfer device. The cross-bar type transfer device includes a blank attachment member, adaptable to specific blank shapes, that enables transfer of large blank materials without sufficient rigidity for quicker or simpler transport methods. The finger-type transfer includes multiple fingers suitable for rapid transport of blank materials that, after initial processing, have sufficient rigidity for rapid transport.

### BACKGROUND TO THE PRESENT INVENTION

1. Field of the Invention

The present invention relates to a transfer device equipped with feed bars having fingers for gripping an end part of a blank. The present invention further relates to a transfer device equipped with cross bars having a blank attachment member.

2. Description of the Related Art

For conventional transfer devices, transferring a feed-bar-type blank, a typical method of transfer is to grasp an end part of the blank material with a clamping motion. This clamping motion method is conventionally actuated by a pair of feed bars arranged parallel to each other. The clamping motion operation is conducted at an approximate stroke rate of 45 strokes per minute. Blank materials, beyond about 1300 mm, have minimal linear rigidity and sagging is frequent. As a result, the clamping operation, and subsequent transfer, is awkward.

With larger blank materials (for example, 2500 mm or greater), a cross-bar method for transfer is conventionally used. In the cross-bar method, a blank attachment member attaches to the upper surface of the blank material prior to transfer. With a lift-and-lower motion, the cross bar first attaches to the blank material and then transfers the blank material to the next processing stage. During processing, the cross-bars are held in a position that does not interfere with a die press or other operation. After the operation, the cross-bars return to the previous stage to transport the next blank material.

In the cross-bar method, the time duration for one cycle is large and the stroke rate per minute is low, typically around 10 per minute. As a result, the productivity rate is reduced. Furthermore, the cross-bar method requires a driving device to move the cross bars. As a result, a device employing the cross-bar method of transfer is large and complex, thereby increasing initial costs, maintenance costs, maintenance downtime, and replacement part costs.

### OBJECTS AND SUMMARY OF THE INVENTION

It is an object of the present invention to provide a transfer device that has a high rate of productivity.

It is another object of the present invention to provide a transfer device that minimizes operational errors due to blank flexing.

It is another object of the present invention to provide a transfer device that is generally compact and jointly employs two types of transfer devices.

It is another object of the present invention to provide a transfer device that incorporates the use of both a cross bar and a clamping motion to rapidly transfer products through processing stages at a desirable feed rate.

Briefly stated the present invention relates to a transfer device for transferring large pliable blank materials through multi-stage processing by engaging both a cross-bar-type and a finger-type transfer devices along a process path. The cross-bar type transfer device includes a blank attachment member, adaptable to specific blank shapes, thus enabling transfer of large blank materials, which prior to processing, do not have sufficient rigidity for simpler transport methods. The finger-type transfer includes multiple fingers suitable for rapid transport of blank materials that, after initial processing, have sufficient rigidity for rapid transport.

According to an embodiment of the invention, there is provided a transfer device, comprising: at least a first pair of feed bars provided parallel to each other, said feed bars having an upstream side and a downstream side, a bolster member extending below said feed bars, said feed bars operable away from and laterally along said bolster, a first transfer means provided along said feed bars on said upstream side, said first transfer means engagable with an external blank, a second transfer means provided along said feed bars on said downstream side, said second transfer means engagable with said external blank, and said first means and said second means operating in sequence whereby said external blank is transported from said downstream side along said feed bars to said upstream side.

According to another embodiment of the present invention there is provided a transfer device, comprising: at least a first guide affixed on an upper surface of each said cross bar along said downstream side.

According to another embodiment of the present invention there is provided a transfer device wherein said first transfer means comprises: at least a first pair of cross bars spanning said feed bars, said cross bars each having a opposite facing end affixed in said guide, said cross bars each having a second end slidably guided in said guide, a plate joined to said cross bars along a center portion of said cross bars, a blank attachment member provided on said plate, a pinion rotatably provided on said plate, a rack formed in a center portion of said feed bars, said pinion meshing with said rack, and said rack operable through an external driver whereby said plate is adjustable and operable away from said bolster according to said feed bars and said external driver whereby said external blank is progressively transported.

According to another embodiment of the present invention there is provided a transfer device wherein said second transfer means comprises: at least a first pair of opposing finger members, said finger members extending toward each other between said feed bars, said finger members adjustable relative to said feed bars and said bolster to engage said external blank, said finger members operating according to said feed bars and engaging said external blank whereby said external blank is progressively transported.

According to another embodiment of the present invention there is provided a transfer device further comprising: a first conveyor on said upstream side opposite said cross bars, said first conveyor providing said external blank to said upstream side, a second conveyor on said down stream side opposite said feed bars, said second conveyor receiving said external blank from said downstream side, at least a first and second pair of guide parts along said feed bars, at least a first and second clamp lift unit below said feed bars, said first and second clamp lift unit lifting and guiding to said first and second guide parts, a slider provided along said downstream side of said feed bars, said slider guidably affixed to said downstream side of said feed bars, and said slider reciprocating with said feed bars whereby said external blank is provided to said downstream side and said second conveyor after processing.

According to another embodiment of the present invention there is provided a transfer device, comprising: a pair of feed bars provided parallel to each other and having an idle stage on an upstream side and at least a first and second stage on a downstream side, a first transfer means spanning said feed bars on said upstream side, said first transfer means including a pair of cross bars and a blank attachment member, said blank attachment member attachable to an external blank, a second transfer means provided along said feed bars on said downstream side, said second transfer means including at least a first pair of finger parts, said finger parts attachable to said external blank, and said first transfer means transferring said external blank from said idle stage to said first stage and said second transfer means transferring said external blank from said first stage to at least second stage whereby said external blank is progressively transported.

According to another embodiment of the present invention there is provided a transfer device, further comprising: a rack member formed in a center portion of said pair of cross bars, at least a first guide affixed on an upper surface of each said feed bar, a facing end and an opposite end on each said cross bar, said facing end of said cross bars affixed on said guides and said opposite end of said guide bars slidably guided in said guides, a plate joined adjacent a center portion of said cross bars, a pinion rotatively provided on said plate, and said pinion rotatively meshing with said rack member whereby adjustment is provided to said plate and said cross bars.

The present invention uses cross bars that have a blank attachment member and which are suitable for transferring large blank materials that, prior to processing, do not have sufficient rigidity. The present invention also jointly uses fingers that are suitable for rapid transport of blank materials that, after processing, are molded and have rigidity.

The above, and other objects, features and advantages of the present invention will become apparent from the following description read in conjunction with the accompanying drawings, in which like reference numerals designate the same elements.

### BRIEF DESCRIPTION OF THE FIGURES

FIG. 1 is a plan view of a transfer device.

### DESCRIPTION OF THE PREFERRED EMBODIMENTS

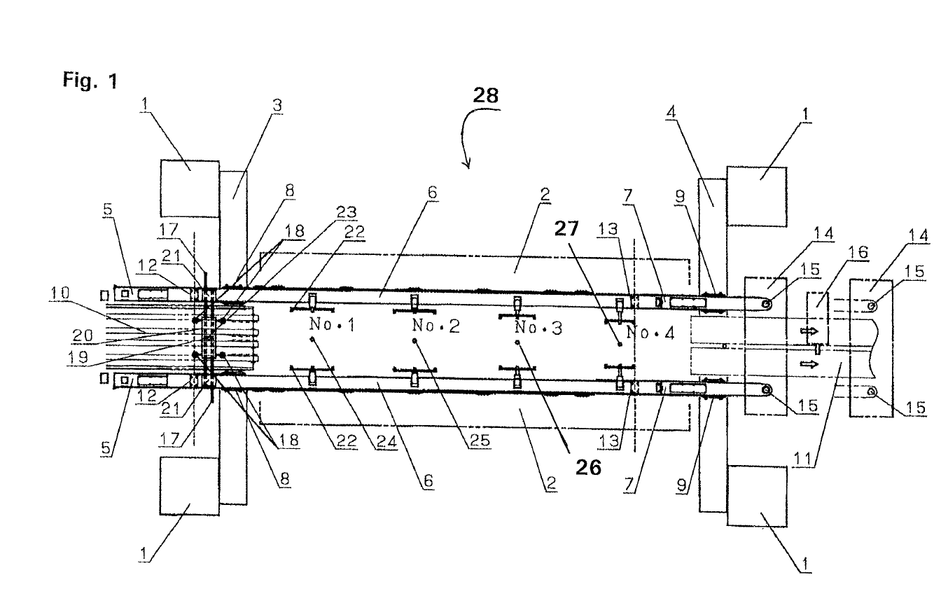

Referring now to FIG. 1, a press machine 28 is equipped with a bed, not shown and employs the present invention as a transfer device. A crown, also not shown, is supported on the bed by columns 1. Columns 1 are on each outside corner of press machine 28. A bolster 2, is fixed on top of the bed. It is to be understood, that while bolster 2 is fixed to the bed in this embodiment, the bolster 2 may be shiftably provided on the bed, depending upon customer demand.

A slide, not shown, moves vertically with respect to bolster 2. A plurality of lower and upper molds, not shown, are on the opposing surfaces of bolster 2 and the slide.

Feed bars 5, 6, and 7 are arranged in pairs, parallel to each other, along the top of bolster 2. Feed bars 5, 6, and 7 transport the blank materials from die to die during the operation of press machine 28.

Feed bars 5, 6, and 7 are in three sections. A joint 12, allows separation of feed bars 5 from feed bars 6 for adjustment and maintenance. Similarly, ajoint 13 allows separation of feed bars 6 from feed bars 7. As a result, it is easy when exchanging dies or other operations, to remove feed bars 6 together with moving bolster 2.

A slider 14 guides feed bars 5, 6, and 7 in the transfer direction. Slider 14 is linked to one end of feed bars 7. A pair of upright pins 15 are on slider 14, extending away from the horizontal surface. Upright pins 15 are insertable into holes, not shown, positioned on the end of feed bars 7. As a result, slider 14 is connected to feed bars 7.

During operation, slider 14 conducts an reciprocating advance-return motion. A servo motor 16, having a rack-pinion construction, not shown, serves as a driving means for the advance-return motion of slider 14. Through pins 15, feed bars 5, 6, and 7 also conduct an advance-return motion in conjunction with the advance-return motion of slider 14.

During reciprocation, pairs of U-shaped guide parts 8 and 9 guidably receive feed bars 6 and 7. Guide parts 8, 9 conduct a clamp-unclamp motion on feed bars 6 and 7. A pair of clamp-lift units 3 and 4 extend away from bolster 2 toward columns 1. Clamp-lift units 3 and 4 each have a ball-screw mechanism, not shown. The ball-screw mechanism serves as a driving means for a servo motor, not shown, on clamp lift units 3 and 4. The servo motor operates clamp-lift units 3 and 4 in the clamp-unclamp motion on feed bars 6 and 7. As a result, guide parts 8 and 9 conduct a lifting and lowering motion with a rack-pinion mechanism. The rack-pinion mechanism has, as a driving means, a separate servo motor positioned inside clamp lift units 3 and 4.

In the above discussion, feed bars 5, 6, and 7 may conduct two or three-dimensional motions, or both. However, feed bars 5, 6, and 7 may alternatively be constructed to conduct only a two-dimensional motion along a horizontal plane according to manufacturer need or customer desire. Where this alternative construction occurs, a cylinder(not shown) is provided on a blank attachment member 18, attached to a cross bar 17. The cylinder conducts the lifting and lowering motion of blank attachment member 18.

A conveyor belt 10 and a conveyor belt 11 are on opposite sides of the transfer device. It is to be understood that, conveyor belts 10, 11 may be formed in as a single or multiple belt unit. Conveyor belt 10 brings blank materials to an idle stage 23 at a constant rate. Idle stage 23 is positioned on an upstream side in FIG. 1. Conveyor belt 11 transfers the product that has completed the final processing to a down-stream product receiver (not shown).

Feed bars 6 are equipped with cross bars 17 and multiple sets of fingers 22 for gripping an end-part of a blank material. In conjunction with either the above-described two or three dimensional movement, cross bars 17 and fingers 22, grip the blank end-part and transfer each blank to the next processing stage.

A pair of guides 2 1, for installing cross bars 17, affix to feed bars 6 on the upstream side. Cross bars 17 each have two facing ends and two opposite ends. The facing ends of the pair of crossbars 17 are affixed to guides 21. The opposite ends of cross bars 17 are slidably guided in guides 21.

A plate 20 is additionally provided on cross bars 17. A blank attachment member 18, such as a vacuum cup or magnet, is provided on plate 20. Blank attachment member 18 engages a blank material for later processing or transfer. A pinion (not shown) is rotatably fixed on plate 20. A rack (not shown) is formed in the center part of cross bars 17. The rack meshes with the pinion on plate 20. As a result, a rack and pinion mechanism 19 is created by the meshing engagement of the pinion and the rack described above. Blank attachment member 18 is at a middle point between feed bars 6. In sum, the above describes a first transfer device attached to feed bars 6.

As a second transfer device, at least a first pair of fingers 22, formed to grip the blank end-part, attach to feed bars 6. Fingers 22 operate in conjunction with the motion of feed bars 6. Fingers 22 transfer the blank material, brought to a first stage 24 by cross bars 17, to a second stage 25. Fingers 22 transfer the blank material to each subsequent downstream stage provided by a manufacturer. It is to be understood, that while the present embodiment discloses stages 24 through 27, additional operational stages may be included or removed without changing the nature or scope of the invention. Each operational stage 24 through 27 is associated with a process number No. 1-4, as shown on FIG. 1. It is to be understood, that process and stage order are positioned according to manufacturer or customer demand.

The first and second transfer devices allow the transfer and operation of press machine 28. The blank material, initially transferred to idle stage 23 by conveyor belt 10, is brought to first stage 24 by blank attachment member 18. The blank material is then molded by die process No. 1. In the present embodiment, it is to be understood, that the first stage 24 process is a process whereby the blank is stiffened by a bending or molding process to form a stiffened but further unworked blank. Thus, after initial forming, the blank material is sufficiently stiff to be transferred by fingers 22.

After initial formation, the blank material is then transferred from first stage 24 to second stage 25 by fingers 22. Fingers 22 operate by gripping the blank end-part. A product is molded in sequence at each of the stages downstream from second stage 25. Conveyor belt 11 brings a final product to a product receiver, not shown.

In the present invention, cross bars 17 with blank attachment member 18 are used for carrying the blank material to first stage 24 when a sagging blank material is a processing concern. After first stage 24, the blank material is molded and is understood to be sufficiently rigid for the transfer by fingers 22 to later stage fingers 22. In other words, with one press machine, two types of transfer devices are used together. As a result, an commercial advantages is realized in terms of cost and high productivity.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents but also equivalent structures. Thus although a nail and screw may not be structural equivalents in that a nail relies entirely on friction between a wooden part and a cylindrical surface whereas a screws helical surface positively engages the wooden part, in the environment of fastening wooden parts, a nail and a screw may be equivalent structures.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A transfer device, comprising:
at least a first pair of feed bars parallel to each other;
a bolster extending below said feed bars;
said feed bars operable away from and laterally along said bolster;
a first transfer means along an upstream side of said feed bars;
said first transfer means engagable with an external blank;
a second transfer means along a downstream side of feed bars;
said second transfer means engagable with said external blank; and
said first means and said second means operating in sequence to transport said external blank from said upstream side along said feed bars to said downstream side whereby the speed of said transfer device is increased.

2. A transfer device according to claim 1, comprising:
at least a first pair of guides; and
each said guide on a first surface of each said cross bar.

3. A transfer device according to claim 2, further comprising:
at least a first and second cross bar orthogonal on said feed bars;
said cross bars having a first and a second end;
said first ends proximate said second ends;
said first ends adjustably fitted in said guides;
said second end slidably guided in said guides;
a plate supported by and joined to said cross bars;
a blank attachment member on said plate to attach an external blank;
a pinion rotatably attached to said plate;
a rack formed at a center section of said feed bars;
said pinion meshing with said rack;
said rack operable through an external driver; and
said rack operating said plate and said blank attachment member to transport said blank toward said downstream side, whereby the speed of said transport device is increased.

4. A transfer device according to claim 3, further comprising:
at least a first pair of finger members;
said finger members extending toward each other between said feed bars;
said finger members adjustable relative to said feed bars and said bolster to engage said external blank; and
said finger members operating according to said feed bars to engage said external blank and progressively transport said external blank toward said downstream side, whereby the speed of said transfer device is increased.

5. A transfer device according to claim 4, further comprising:
a first conveyor between said feed bars on said upstream side;
said first conveyor providing said external blank to said upstream side;
a second conveyor opposite said feed bars on said downstream side;
said second conveyor receiving said external blank from said downstream side;
at least a first and second pair of guide parts along said feed bars;
at least a first and second clamp lift unit below said feed bars;
said first and second clamp lift unit lifting and guiding to said first and second guide parts;
a slider along said downstream side of said feed bars;
said slider guidably fixed to said feed bars; and
said slider reciprocating with said feed bars to provide external blank to said downstream side and said second conveyor whereby the speed of said transfer device is increased.

6. A transfer device, comprising:
a pair of feed bars parallel to each other;
said feed bars having an idle stage on an upstream side and at least a first and second stage on a downstream side;
a first transfer means spanning said feed bars on said upstream side;
said first transfer means including a pair of cross bars and a blank attachment member;
said blank attachment member attachable to an external blank;
a second transfer means provided along said feed bars on said downstream side;
said second transfer means including at least a first pair of finger parts;
said finger parts attachable to said external blank; and
said first transfer means transferring said external blank from said idle stage to said first stage and said second transfer means transferring said external blank from said first stage to said second stage to transport said external blank to said downstream side whereby said external blank is rapidly transported.

7. A transfer device, according to claim 6, further comprising:
a rack formed in a center portion of said cross bars;
at least a first guide affixed on an upper surface of each said feed bar;
a facing end and an opposite end on each said cross bar;
said facing end of said cross bars affixed on said guides;
said opposite end slidably guided in said guides;
a plate joined proximate said center portion of said cross bars;
a pinion rotatively provided on said plate; and
said pinion rotatively meshing with said rack member to provide adjustment to said plate and said cross bars whereby said external blank is rapidly transported.
